(19) United States
(12) Patent Application Publication
(10) Pub. No.: US 2021/0342584 A1
(43) Pub. Date: Nov. 4, 2021

(54) OBJECT RECOGNITION DEVICE, OBJECT RECOGNITION METHOD, AND PROGRAM STORAGE MEDIUM

(71) Applicant: NEC Corporation, Minato-ku, Tokyo (JP)

(72) Inventor: Hideaki SATO, Tokyo (JP)

(73) Assignee: NEC Corporation, Minato-ku, Tokyo (JP)

(21) Appl. No.: 17/270,566

(22) PCT Filed: Aug. 29, 2018
(86) PCT No.: PCT/JP2018/031853

§ 371 Date: Feb. 23, 2021

(51) Int. Cl. G06K 9/00; G06T 7/246; G06K 9/46; G06K 9/62

(52) U.S. Cl. CPC G06K 9/00624; G06K 9/629; G06K 9/46; G06T 7/246

(57) ABSTRACT

An object recognition device includes an appearance feature generation unit, a movement feature generation unit, a feature combining unit, and a recognition unit to recognize the moving object in the captured image with high precision even if the area of the moving object in the captured image varies due to movement in the direction receding from/approaching to an imaging device. The appearance feature generation unit extracts, as an appearance feature, an appearance-related feature from an image of the moving object in the captured image. The movement feature generation unit normalizes a movement amount of the moving object in the captured image to calculate a value obtained by the normalization as a movement feature. The feature combining unit combines the appearance feature with the movement feature. The recognition unit recognizes the moving object using information obtained by the feature combining unit.

### TECHNICAL FIELD

The present invention relates to a technique for recognizing a moving object detected in a captured image.

### BACKGROUND ART

A camera has been used to monitor and recognize a moving object. For example, according to the technique disclosed in PTL 1, temporal changes are observed for each pixel of an image captured by a camera, and a moving object and a background are recognized using a result of the observation. According to the technique disclosed in PTL 2, a type of a moving object is recognized using a movement amount of the moving object and a shape of the moving object in a captured image.

### CITATION LIST

### Patent Literature

[PTL 1] JP 2007-323572 A

[PTL 2] JP H08-106534 A

[PTL 3] JP 2011-192090 A

[PTL 4] JP 2006-318064 A

### SUMMARY OF INVENTION

### Technical Problem

In the technique of PTL 1, while the moving object and the background can be recognized, a type of the moving object is not recognized. In the technique of PTL 2, while a type of the moving object is recognized, a distance between an installed camera and the moving object is not considered, whereby the accuracy in recognition of the moving object is lowered for the following reasons. That is, as illustrated in FIG. 1, in a case where distances L1 and L2 between a camera 120 and a moving object 110 are different, a movement amount of the moving object 110 in images A and B captured by the camera 120 differs even though the camera 120 images the same moving object 110 (e.g., bird) moving at a similar speed and migratory path. According to the technique of PTL 2, a type of the moving object is recognized using a movement amount of the moving object in the captured image, whereby the same moving object 110 is determined to be a different moving object 110 when the movement amount of the moving object in the captured image is different. Since such a situation occurs, the accuracy in recognizing the moving object 110 is lowered in the technique of PTL 2.

A main object of the present invention is to provide a technique related to a process of recognizing a moving object in a captured image, which makes it possible to recognize a moving object in a captured image with high precision even if the area of the moving object in the captured image varies due to movement in the direction receding from/approaching to an imaging device.

### Solution to Problem

In order to achieve the object described above, one aspect of an object recognition device includes:

an appearance feature generation unit that extracts, as an appearance feature, an appearance-related feature from an image of a moving object in a captured image;

a movement feature generation unit that normalizes a movement amount of the moving object in the captured image to calculate a value obtained by the normalization as a movement feature;

a feature combining unit that combines the appearance feature with the movement feature; and

a recognition means that recognizes the moving object using information obtained by the feature combining unit.

One aspect of an object recognition method causes a computer to perform:

extracting, as an appearance feature, an appearance-related feature from an image of a moving object in a captured image;

normalizing a movement amount of the moving object in the captured image to calculate a value obtained by the normalization as a movement feature;

combining the appearance feature with the movement feature; and

recognizing the moving object using information obtained by the combining of the appearance feature with the movement feature.

One aspect of a program storage medium stores a computer program causing a computer to perform:

extracting, as an appearance feature, an appearance-related feature from an image of a moving object in a captured image;

normalizing a movement amount of the moving object in the captured image to calculate a value obtained by the normalization as a movement feature;

combining the appearance feature with the movement feature; and

recognizing the moving object using information obtained by the combining of the appearance feature with the movement feature.

### Advantageous Effects of Invention

According to the present invention, in a process of recognizing a moving object in a captured image, it becomes possible to recognize the moving object in the captured image with high precision even if the area of the moving object in the captured image varies due to movement in the direction receding from/approaching to an imaging device.

### BRIEF DESCRIPTION OF DRAWINGS

FIG. 1 is a diagram illustrating a difference in a movement amount of a moving object in a captured image caused by a difference in distance between a camera and the moving object.

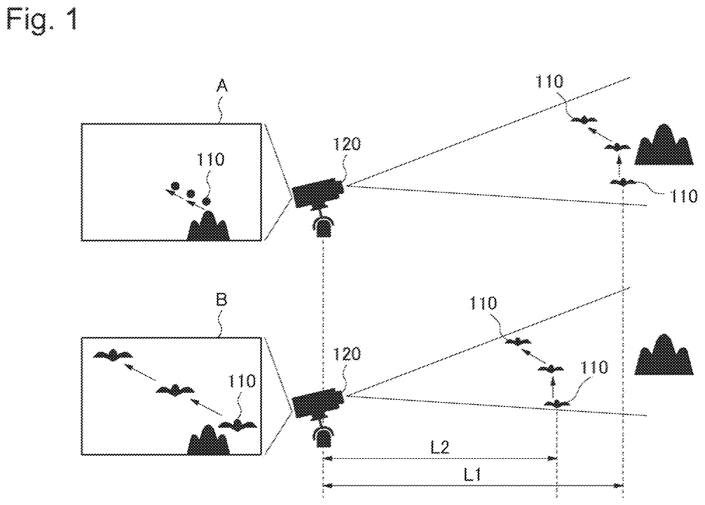

FIG. 2 is a block diagram illustrating a configuration of an object recognition device according to a first example embodiment of the present invention.

FIG. 3 is a diagram illustrating a method of calculating a movement feature according to the first example embodiment.

FIG. 4 is a flowchart illustrating an exemplary operation for recognizing a moving object in the object recognition device according to the first example embodiment.

FIG. 5 is a diagram illustrating a method of calculating a movement feature according to a second example embodiment.

### EXAMPLE EMBODIMENT

Example embodiments of the present invention will be described with reference to the accompanying drawings.

### First Example Embodiment

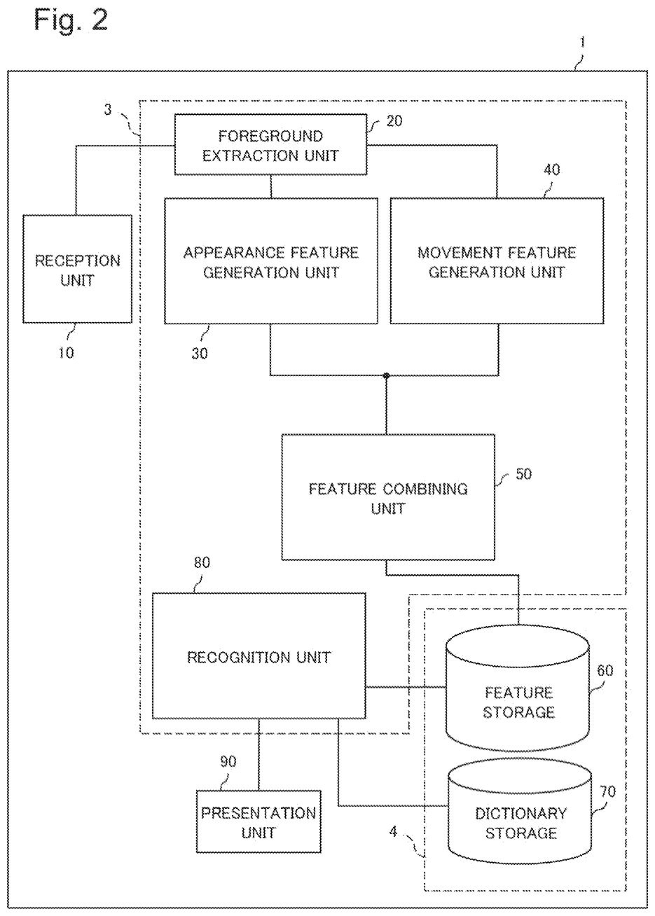

FIG. 2 is a block diagram conceptually illustrating a configuration of an object recognition device according to a first example embodiment of the present invention. An object recognition device 1 according to the first example embodiment includes a reception unit 10, a foreground extraction unit 20, an appearance feature generation unit 30, a movement feature generation unit 40, a feature combining unit 50, a feature storage 60, a dictionary storage 70, a recognition unit 80, and a presentation unit 90.

The reception unit 10 obtains (receives), for example, a captured image (moving image and/or still image) captured using an imaging device such as a video camera from the imaging device and/or a storage device storing the captured image.

The foreground extraction unit 20 has a function of separating the captured image received by the reception unit 10 into a foreground area and a background area. Examples of a method to be used in the process of separation into the foreground and the background include a background subtraction method and a method using an optical flow.

The appearance feature generation unit 30 has a function of extracting, as an appearance feature, an appearance-related feature of the object from the image of the object included in the foreground area obtained by the foreground extraction unit 20. Examples of a method to be used in the process of extracting a feature include a feature extraction method based on a neural network, a method of extracting gradient information or a histogram of oriented gradients (HOG) as a feature, and a method of extracting a Haar-like feature. The captured images from which the appearance feature generation unit 30 extracts the appearance feature may not necessarily be all the captured images processed by the foreground extraction unit 20.

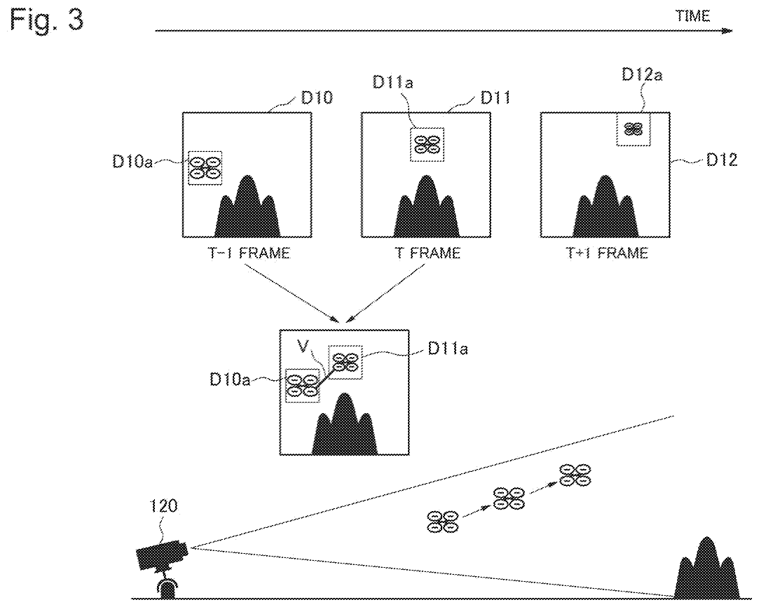

The movement feature generation unit 40 has a function of calculating information (movement feature) related to movement of moving objects (e.g., flight vehicles such as drones, cars, and birds) using the foreground area image obtained by the foreground extraction unit 20. FIG. 3 is a diagram illustrating an exemplary process of calculating a movement feature. An exemplary method of calculating a movement feature using the movement feature generation unit 40 will be described below with reference to FIG. 3. Frames D10, D11, and D12 illustrated in FIG. 3 are temporally continuous frames in a captured image (moving image), which are arranged in time order.

The movement feature generation unit 40 calculates a movement amount V of the moving object in the captured image using, for example, a foreground area D10a of the frame D10 (T−1 frame) and a foreground area D11a of the frame D11 (T frame) obtained by the foreground extraction unit 20. Then, the movement feature generation unit 40 normalizes the calculated movement amount V using rectangular areas S10 and S11 of the foreground areas D10a and D11a, and generates (calculates), as a movement feature, a value M obtained by the normalization. Specifically, the movement feature generation unit 40 calculates the value M obtained by normalizing the movement amount in accordance with the formula (1), for example.

M=V/(S10+S11)^{1/2} (1)

Alternatively, the movement feature generation unit 40 may calculate the value M obtained by normalizing the movement amount in accordance with the formula (2).

M=V/(S10/S11) (2)

In the formulae (1) and (2), V represents a movement amount of the moving object in the captured image, and M represents a normalized value of the movement amount V. In addition, S10 represents an area (or the number of pixels) of the foreground area D10a in the captured image, and S11 represents an area (or the number of pixels) of the foreground area D11a in the captured image.

In a case where the moving object is moving in the direction receding from/approaching to the imaging device, the area of the moving object in the image captured by the imaging device changes even in the case of the same moving object. Therefore, as described above, the movement amount of the moving object in the captured image is normalized using the area of the moving object in the captured image, whereby it becomes possible to obtain a movement feature in which the variation in distance between the imaging device and the moving object moving in the direction receding from/approaching to the imaging device is absorbed.

The frames used by the movement feature generation unit 40 to calculate a movement feature may not necessarily be temporally continuous frames. The number of frames to be used by the movement feature generation unit 40 to calculate a movement feature may be equal to or more than three. In the case of calculating the value M by normalizing the movement amount in accordance with the formula (1), the square root of the sum of the areas of the foreground areas in a plurality of frames is used. Alternatively, the movement amount V may be normalized by using the average value, the median value, the square root of the median value, or the like of the areas of the foreground areas in the plurality of frames. Furthermore, the movement feature generation unit 40 may set a plurality of groups including a plurality of frames (e.g., two frames) in, for example, equal to or more than four frames, calculate the value M obtained by normalizing the movement amount for each group, and calculate, as a movement feature, the average, variance, median value, representative value, total, or the like of a plurality of the calculated values M. As a method for calculating the value M for each group, for example, the area ratio of the foreground areas, the square root of the sum of the areas, the average value or the median value of the areas, the square root of the median value, or the like in the plurality of frames as described above is used. Meanwhile, an image area of a flying bird in a captured image irregularly changes due to flapping, a change in direction, and the like. As described above, even in a case where the area of the moving object in the captured image changes, it is possible to obtain, by increasing the number of frames to be used to calculate a movement feature, the movement feature in which the influence of the change in image area of the moving object is suppressed.

The feature combining unit 50 has a function of combining the appearance-related feature (appearance feature) of the object extracted by the appearance feature generation unit 30 with the movement feature calculated by the movement feature generation unit 40. For example, the information obtained by the combination is represented by a mode in which the appearance feature is expressed as a vector and the movement feature is combined at the end of the vector, or by a graph structure.

The feature storage 60 retains the information obtained by the feature combining unit 50 as a feature of the moving object.

The dictionary storage 70 stores a dictionary that is a recognition model learned by using the information stored in the feature storage 60. A model appropriately selected from a plurality of kinds of models such as a neural network and a support vector machine in consideration of the resolution of the captured image, device performance, and the like is adopted as a recognition model, and a dictionary based on the adopted recognition model is stored in the dictionary storage 70.

The recognition unit 80 has a function of referring to the model stored in the dictionary storage 70 and recognizing a type of the moving object in the captured image using the information associated with the moving object captured in the captured image, the information being obtained by the feature combining unit 50.

The presentation unit 90 presents a result of the recognition unit 80 to a user.

The feature storage 60 and the dictionary storage 70 are constructed by a storage device 4 such as a magnetic disk device and a semiconductor memory. The foreground extraction unit 20, the appearance feature generation unit 30, the movement feature generation unit 40, the feature combining unit 50, and the recognition unit 80 are constructed by a control device 3 including a processor such as a central processing unit (CPU) and a graphics processing unit (GPU), for example. In other words, the processor of the control device 3 can function as the foreground extraction unit 20, the appearance feature generation unit 30, the movement feature generation unit 40, the feature combining unit 50, and the recognition unit 80 by executing a computer program read from the storage device 4. While the method by which the presentation unit 90 presents the result of the recognition unit 80 is not particularly limited as long as the user can understand the recognition result of the moving object, examples of the presentation method include a method of presentation based on voice using a speaker, a method of presentation based on display of characters, photographs, and the like using a display, and a method combining a plurality of such presentation methods.

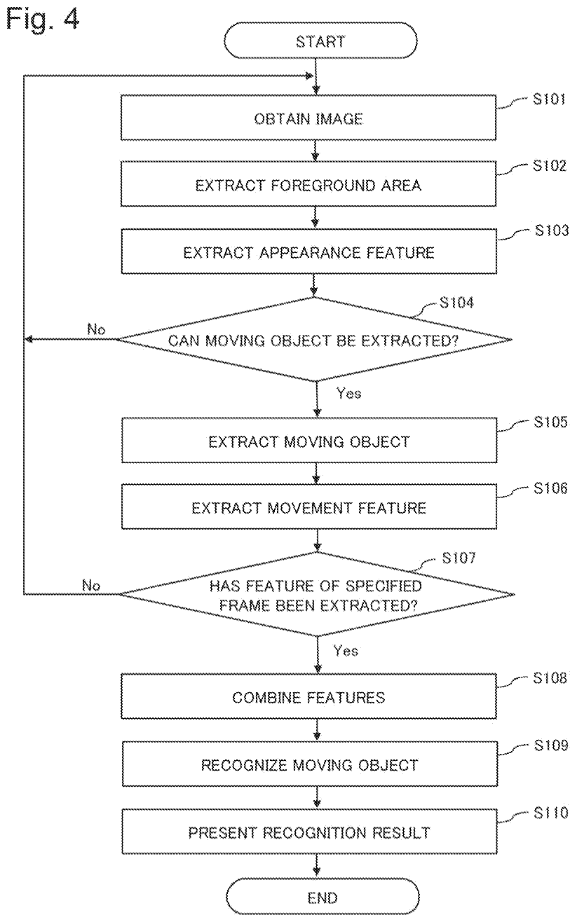

Next, an exemplary operation of the object recognition device 1 according to the first example embodiment will be described with reference to FIG. 4. FIG. 4 is a flowchart illustrating exemplary processing steps for recognizing a moving object performed by the object recognition device 1.

For example, the reception unit 10 obtains a captured image from an imaging device such as a camera or an external storage device (step S101).

The foreground extraction unit 20 separates the captured image obtained through the reception unit 10 into a foreground area and a background area, and extracts the foreground area from the captured image (step S102). The appearance feature generation unit 30 extracts an appearance feature from the moving object image in the foreground area obtained by the foreground extraction unit 20 (step S103).

Subsequently, the movement feature generation unit 40 uses the image information of the foreground area and the background area obtained by the foreground extraction unit 20 to determine whether the moving object can be extracted from a plurality of captured images having the same imaging range and different imaging times (step S104). If the moving object cannot be extracted, the object recognition device 1 performs the operation of step S101 and subsequent steps again. If the moving object can be extracted, the movement feature generation unit 40 extracts the moving object from the foreground area image obtained by the foreground extraction unit 20 (step S105). Then, the movement feature generation unit 40 extracts a movement feature from the extracted image of the moving object (step S106).

Then, the feature combining unit 50 determines whether an appearance feature and a movement feature have been extracted by the appearance feature generation unit 30 and the movement feature generation unit 40 with regard to a plurality of frames (captured images) specified as a processing target (step S107). If they have not been extracted, the object recognition device 1 performs the operation of step S101 and subsequent steps again. If they have been extracted, the feature combining unit 50 combines the movement feature with the appearance feature in the plurality of frames (captured images) to be processed (step S108), and stores the information obtained by the combination in the feature storage 60.

Subsequently, the recognition unit 80 refers to the dictionary in the dictionary storage 70 and recognizes a type of the moving object in the captured image using the information associated with the moving object captured in the captured image, the information being obtained by the feature combining unit 50 (step S109). The presentation unit 90 presents the result of the recognition by the recognition unit 80 to the user (step S110).

The processing steps described here are only examples, and the order of processing execution may be changed as appropriate.

Description of Effects

According to the object recognition device 1 and the object recognition method to be executed by the object recognition device 1 according to the first example embodiment, a moving object in a captured image can be recognized with high precision even if the area of the moving object in the captured image varies due to movement in the direction receding from/approaching to an imaging device. This is because, according to the object recognition device 1 and the object recognition method according to the first example embodiment, a movement amount of the moving object in the captured image is normalized using the area of the moving object in such a way that the variation in distance between the imaging device and the moving object moving in the direction receding from/approaching to the imaging device is absorbed. In other words, the object recognition device 1 according to the first example embodiment uses the fact that the physical size of the moving object does not change to treat the size of the moving object reflected in the captured image like a ruler, and generates a feature that absorbs a difference in positional relationship between the imaging device and the moving object moving in the direction receding from/approaching to the imaging device. The object recognition device 1 according to the first example embodiment recognizes the moving object using the feature, whereby the same type of object with the same physical movement amount, which cannot be determined only by the movement amount on the plane in the captured image, can be recognized with high precision.

### Second Example Embodiment

Hereinafter, a second example embodiment of the present invention will be described. In the description of the second example embodiment, parts with names same as those of constituent elements included in the object recognition device according to the first embodiment are denoted by the same reference signs, and duplicate descriptions of the common parts will be omitted.

In the second example embodiment, a method of calculating a movement feature using a movement feature generation unit 40 is different from that in the first embodiment. Other configurations in an object recognition device 1 according to the second example embodiment are similar to those in the first embodiment.

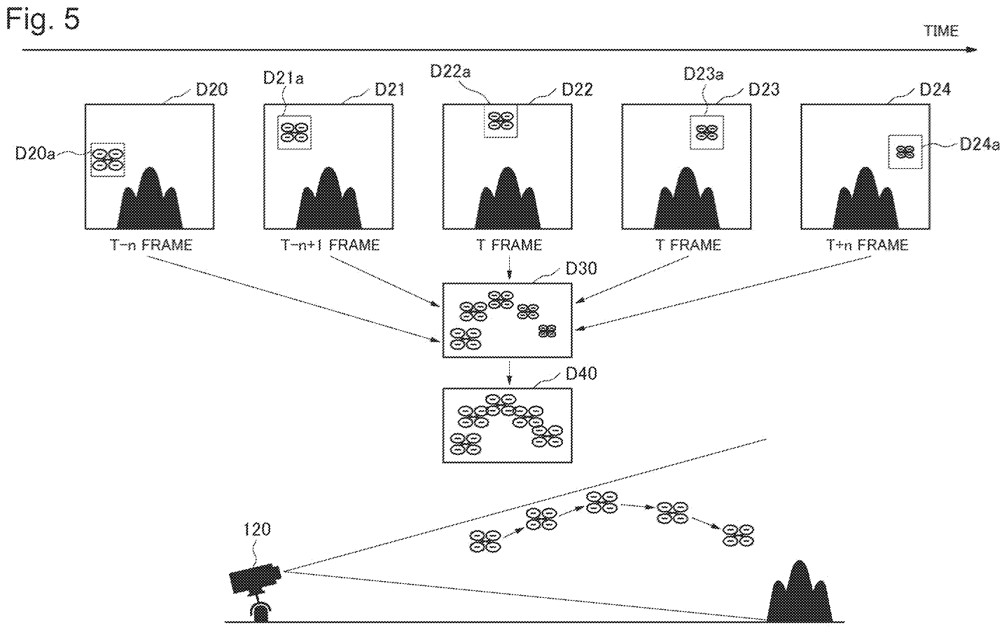

FIG. 5 is a diagram illustrating a method of calculating a movement feature according to the second example embodiment. Frames D20, D21, D22, D23, and D24 illustrated in FIG. 5 are temporally continuous frames in a captured image (moving image), which are arranged in time order.

The movement feature generation unit 40 cuts out foreground areas D20a to D24a detected by a foreground extraction unit 20 from the frames D20 to D24 of the specified number of frames to be processed (N (five in the example of FIG. 5)), and generates an image D30 including all of them. Furthermore, the movement feature generation unit 40 converts the generated image D30 into a movement amount normalized image D40, thereby calculating, as a movement feature, a normalized movement amount of the moving object in the captured image. The feature is generated as a feature that absorbs the difference in distance between the imaging device and the moving object. Note that N, which is the number of frames to be processed, is appropriately set in consideration of the conditions in the range to be imaged by the imaging device.

Next, a specific example of a method for converting the image D30 into the movement amount normalized image D40 will be described. Here, a breadth size of the movement amount normalized image D40 is defined as W_{D40}, and a length size is defined as H_{D40}. A variable is defined as i, which is an integer in a range more than −n and equal to or less than n in a case where an integer of a half of the specified number of frames N to be processed is defined as n (−n<i≤n). Furthermore, when the coordinates of the upper left and lower right of the rectangle surrounding the foreground area in the captured image of a T+i frame are defined as (Xleft_i, Yleft_i) and (Xright_i, Yright_i), respectively, the breadth size W_{D30} and the length size H_{D30} of the image D30 including the foreground area in the captured image of all the T+i frames can be expressed as W_{D30}=Max(Xright_i)−Min(Xleft_i), H_{D30}=Max(Yleft_i)−Min(Yright_i).

In order to convert the image D30 into the movement amount normalized image D40, the movement feature generation unit 40 multiplies the breadth and length sizes of the foreground area in the captured image of the T+i frame by a breadth scale element Sw=W_{D40}/W_{D30} and a length scale element S_{H}=H_{D40}/H_{D30}. As a result, the movement feature generation unit 40 converts the image D30 into the movement amount normalized image D40.

As described above, the object recognition device 1 and the object recognition method according to the second example embodiment calculate a movement feature by normalizing the image size using the movement feature generation unit 40, and recognizes the moving object in the captured image using the movement feature. The object recognition device 1 and the object recognition method according to the second example embodiment can also obtain effects similar to the effects obtained by the object recognition device 1 and the object recognition method according to the first example embodiment.

The object recognition device 1 and the object recognition method described in the first and second example embodiments may be applied to monitoring of birds and drones necessary for operation management of flying objects such as drones in physical distribution, for example.

The present invention has been described using the example embodiments described above as model examples. However, the present invention is not limited to those example embodiments described above. That is, various embodiments that can be understood by those of ordinary skill in the art may be applied without departing from the spirit and scope of the present invention as defined by the claims.

### REFERENCE SIGNS LIST

1 object recognition device

10 reception unit

20 foreground extraction unit

30 appearance feature generation unit

40 movement feature generation unit

50 feature combining unit

60 feature storage

70 dictionary storage

80 recognition unit

90 presentation unit

What is claimed is:

1. An object recognition device comprising:
at least one processor configured to:
extract, as an appearance feature, an appearance-related feature from an image of a moving object in a captured image;
perform normalization of a movement amount of the moving object in the captured image to calculate a value obtained by the normalization as a movement feature;
combine the appearance feature with the movement feature; and
recognize the moving object using information obtained by the combining of the appearance feature with the movement feature.

2. The object recognition device according to claim 1, wherein the at least one processor calculates the movement feature by normalizing the movement amount of the moving object using an area of the moving object in the captured image or a numerical value related to the area.

3. The object recognition device according to claim 1, wherein the at least one processor normalizes the movement amount of the moving object by generating an image including the image of the moving object extracted from each of a plurality of the captured images and normalizing the image.

4. An object recognition method causing a computer to perform:
extracting, as an appearance feature, an appearance-related feature from an image of a moving object in a captured image;
performing normalization of a movement amount of the moving object in the captured image to calculate a value obtained by the normalization as a movement feature;
combining the appearance feature with the movement feature; and
recognizing the moving object using information obtained by the combining of the appearance feature with the movement feature.

5. A non-transitory program storage medium storing a computer program causing a computer to perform:
extracting, as an appearance feature, an appearance-related feature from an image of a moving object in a captured image;
performing normalization of a movement amount of the moving object in the captured image to calculate a value obtained by the normalization as a movement feature;
combining the appearance feature with the movement feature; and
recognizing the moving object using information obtained by the combining of the appearance feature with the movement feature.
